(19) United States
(12) Patent Application Publication
(10) Pub. No.: US 2013/0076175 A1
(43) Pub. Date: Mar. 28, 2013

(54) CONNECTION MODULE FOR A BAR WOUND STATOR ASSEMBLY AND METHOD OF MANUFACTURING A BAR WOUND STATOR ASSEMBLY

(71) Applicants: Paul F. Turnbull, Canton, MI (US); Rodney Carmen Malone, Clarkston, MI (US); Stephen R. Smith, Holly, MI (US); Frederick W. Rhoads, Holly, MI (US); Edward L. Kaiser, Orion, MI (US); Richard Robertson, Wyandotte, MI (US); Brian Schulze, Ortonville, MI (US)

(72) Inventors: Paul F. Turnbull, Canton, MI (US); Rodney Carmen Malone, Clarkston, MI (US); Stephen R. Smith, Holly, MI (US); Frederick W. Rhoads, Holly, MI (US); Edward L. Kaiser, Orion, MI (US); Richard Robertson, Wyandotte, MI (US); Brian Schulze, Ortonville, MI (US)

(21) Appl. No.: 13/240,417

(22) Filed: Sep. 22, 2011

(51) Int. Cl. H02K 3/28

(52) U.S. Cl. 310/71

(57) ABSTRACT

A bar wound stator assembly includes a connection module attached to a stator core at a weld end of the stator assembly. The connection module provides all required electrical connections to connect shaped plurality of hairpin bar connectors of the stator assembly within a first pole pair of a winding set of conductors. All of the hairpin bar conductors include an identical span. The connection module completes each phase of the winding set, to connect each phase of the winding set to define a connection configuration, e.g., a wye or a delta connection configuration, and to connect the stator assembly to all external connections.

### TECHNICAL FIELD

The invention generally relates to an electric device, and more specifically to a stator assembly for the electric device.

### BACKGROUND

Electric devices, including but not limited to induction style electric motors, include a stator assembly. The stator assembly includes a stator core that defines a plurality of radially disposed slots. A plurality of conductors are disposed within the slots and extend along a longitudinal axis of the stator core between and around axial ends of the stator assembly to define a winding set. The conductors may include bar conductors, each having a rectangular cross section. If the stator assembly includes bar conductors, the stator assembly may be referred to as a bar wound stator assembly. The bar conductors are wound at each axial end thereof in order to make the required electrical connections between the bar conductors and/or with external connectors, plugs, or other devices. While many of the bar conductors are identically wound, there are several that include a unique winding in order to make all of the required electrical connections, thereby making the winding process difficult to automate.

### SUMMARY

A stator assembly for an electric device is provided. The stator assembly includes a stator core extending along a longitudinal axis between a first axial end and a second axial end. The stator core defines a plurality of slots that extend along the longitudinal axis, and are angularly spaced about the longitudinal axis. A plurality of bar conductors having an identical span are positioned within the slots to define at least one winding set. The winding set defines multiple phases, and further defines a first pole pair having a first pole and a second pole. The stator assembly further includes a connection module. The connection module is coupled to the stator core at one of the first axial end and the second axial end of the stator core, and spans across the first pole pair of the winding set. The connection module is configured to connect each of the bar conductors of each phase of the first pole pair to complete each phase, and to interconnect each of the multiple phases in a pre-determined connection configuration.

A method of manufacturing a stator assembly for an electrical device is also provided. The method includes forming a stator core to define a plurality of slots, with the slots extending along a longitudinal axis and angularly spaced about the longitudinal axis. A plurality of bar conductors having an identical span are positioned within the plurality of slots to define at least one winding set. The winding set defines multiple phases, and further defines a first pole pair having a first pole and a second pole. A connection module is positioned relative to the stator core to span across the first pole pair. The connection module includes a plurality of electrical jumpers, with each of the jumpers oriented in a pre-determined orientation relative to the stator core to electrically engage at least two pre-determined bar conductors. Each of the electrical jumpers are electrically connected to the at least two pre-determined bar conductors to complete each phase of the winding set, and to interconnect each of the multiple phases in a pre-determined connection configuration.

An electric device is also provided. The electrical device includes a housing, and a rotor assembly rotatably supported by the housing. A stator assembly is supported by and positionally fixed relative to the housing. The rotor assembly is rotatable relative to the stator assembly about a longitudinal axis. The stator assembly includes a stator core that extends along the longitudinal axis between a first axial end and a second axial end. The stator core defines a plurality of slots. The slots extend along the longitudinal axis, and are angularly spaced about the longitudinal axis. A plurality of bar conductors having an identical span is positioned within the slots to define at least one winding set. The winding set defines multiple phases, and further defines a first pole pair having a first pole and a second pole. A connection module is coupled to the stator core at one of the first axial end and the second axial end of the stator core. The connection module spans across the first pole pair of the winding set. The connection module is configured to connect each of the bar conductors of each phase of the first pole pair to complete each phase, and to interconnect each of the multiple phases in a pre-determined connection configuration. The connection module includes an electrically non-conductive substrate supporting a plurality of electrical jumpers. Each of the electrical jumpers is oriented on the substrate in a pre-determined orientation relative to the stator core to electrically engage at least two pre-determined bar conductors. The connection module further includes a flexible lead coupled to the substrate and oriented on the substrate in a pre-determined orientation relative to the stator core to electrically engage a different pre-determined bar conductor associated with each different phase of the winding set. The connection module includes a connection jumper coupled to the substrate and oriented on the substrate in a pre-determined orientation relative to the stator core to electrically connect the phases of the winding set in a pre-determined connection configuration. The connection module further includes a plurality of insulators attached to and supported by the substrate. The insulators extend from the substrate radially toward the longitudinal axis, and extend axially along the longitudinal axis. Each of the insulators is oriented on the substrate in a pre-determined orientation relative to the stator core to electrically insulate between two adjacent bar conductors.

Accordingly, the connection module provides all of the electrical connections required to connect the bar conductors of the stator assembly to complete the winding set. Because all of the electrical connections are provided by the connection module, all of the bar conductors may include an identical span, i.e., no unique bar conductors are required to make the electrical connections. Because all of the bar conductors include the same identical span, the bar winding process used to position the bar conductors in the slots of the stator core may be easily automated. Automating the bar winding process, e.g., through robotic automation, improves consistency and reduces assembly cost of the stator assembly.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic plan view of an electric device.

FIG. 2 is a schematic perspective view of a stator assembly of the electric device.

FIG. 3 is a schematic cross sectional view of the stator assembly.

FIG. 4 is an enlarged schematic plan view of the weld end of the stator assembly.

FIG. 5 is a schematic cross sectional view of the stator assembly taken along cut line 5-5 shown in FIG. 4.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the invention, as defined by the appended claims.

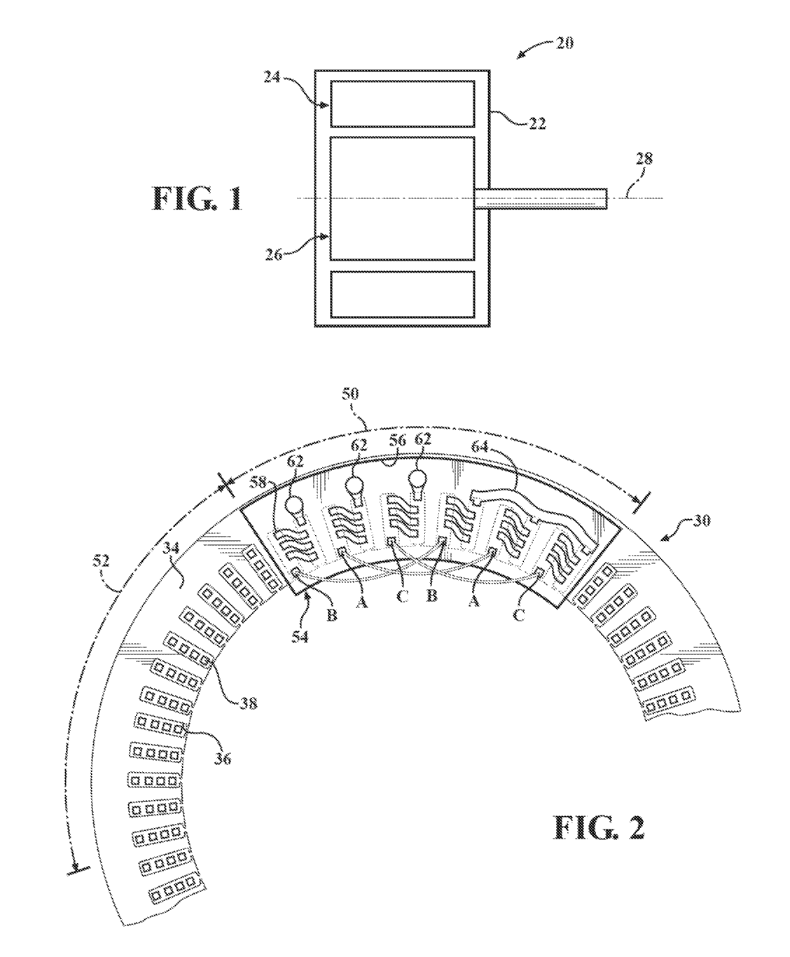

Referring to the Figures, wherein like numerals indicate like parts throughout the several views, an electric device is shown generally at 20 in FIG. 1. The electric device 20 may include but is not limited to an electric motor or other similar device.

Referring to FIG. 1, the electric device 20 includes a housing 22. The housing 22 may be manufactured from any suitable material, including but not limited to aluminum, and may include any suitable size, shape and/or configuration suitable to house the internal components of the electric device 20. The housing 22 supports a stator assembly 24. The stator assembly 24 is positionally fixed relative to the housing 22. The housing 22 rotatably supports a rotor assembly 26. The rotor assembly 26 is rotatable relative to the stator assembly 24 about a longitudinal axis 28. The rotor assembly 26 includes windings or permanent magnets (not shown) that interact with the poles of the stator assembly 24 to generate rotation of the rotor assembly 26 relative to the stator assembly 24.

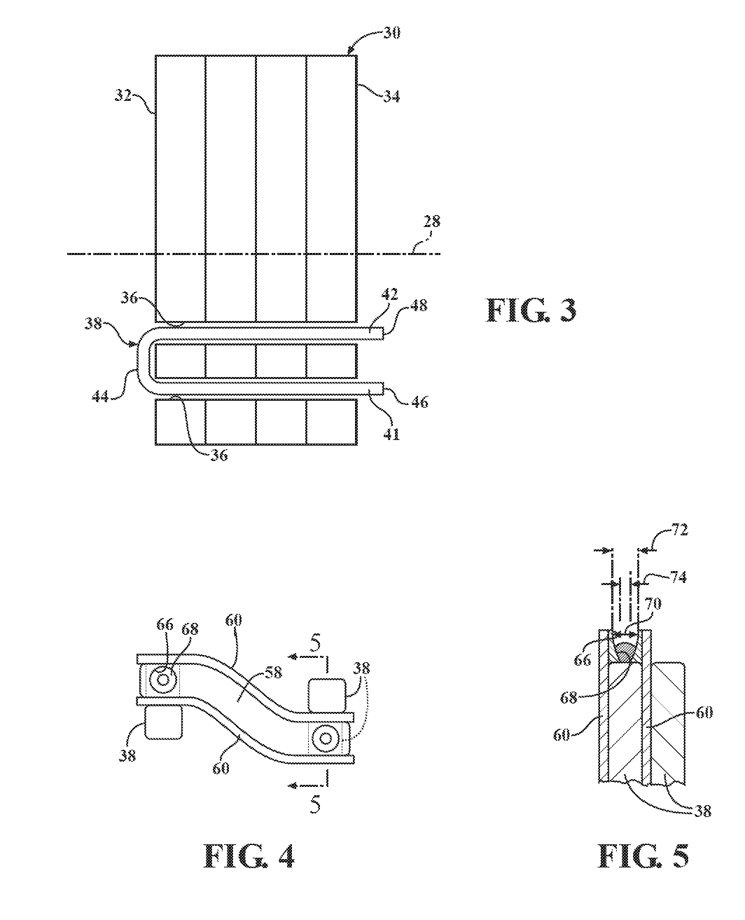

Referring also to FIG. 3, the stator assembly 24 includes a stator core 30. The stator core 30 extends along the longitudinal axis 28, and extends between a first axial end 32 and a second axial end 34 of the stator core 30. The first axial end 32 and the second axial end 34 of the stator core 30 are spaced from each other a length 35 of the stator core 30 measured along the longitudinal axis 28, and are oriented perpendicularly relative to the longitudinal axis 28. Referring to FIG. 2, the stator core 30 defines a plurality of slots 36. The slots 36 extend lengthwise along the longitudinal axis 28, and are angularly spaced about the longitudinal axis 28. The slots 36 are evenly spaced equidistant from each other radially about the longitudinal axis 28.

A plurality of bar conductors 38 are positioned within the slots 36 to define at least one winding set. Each bar conductor 38 spans a pre-determined number of slots, with all of the bar conductors 38 including an identical span. The span of the bar conductors 38 is defined as the angular distance between slots through which a single bar conductor 38 is positioned. Each winding set may define an identical number of phases. Preferably, the winding set defines three phases, i.e., the winding set defines an “A” phase, a “B” phase and a “C” phase. However, the electric device 20 is not limited to a three phase electric device 20, and the number of phases may differ from the three phases shown and described herein.

As best shown in FIG. 2, the bar conductors 38, sometimes referred to as “hairpin conductors,” include a substantially rectangular cross-section. Referring to FIG. 3, the stator core 30 and one of the bar conductors 38 are shown schematically to illustrate the relative positioning of the bar conductors 38 relative to the stator core 30. While the stator assembly includes a plurality of bar conductors 38, FIG. 3 only shows one bar conductor for simplicity and clarity. Each of the plurality of bar conductors 38 includes a crown portion 44, i.e., a “U” shaped end turn, and two leg portions, i.e., a first leg portion 41 and a second leg portion 42. The first leg portion 41 and the second leg portion 42 extend from the crown portion 44 to a first bar end 46 and a second bar end 48 respectively. The first leg portion 41 and the second leg portion 42 of each bar conductor 38 are disposed within different slots 36 of the stator core 30. The crown portion 44 of all of the bar conductors 38 is disposed adjacent the first axial end 32 of the stator core 30 to define a crown end of the stator core 30. The first bar ends 46 and the second bar ends 48 of all of the bar conductors 38 extend past the second axial end 34 of the stator core 30 along the longitudinal axis 28 to define a weld end of the stator core 30.

The first leg portions 41 and the second leg portions 42 of the bar conductors 38 are positioned in the slots 36 of the stator core 30 with each leg portion of each bar conductor 38 in a different slot 36 such that the crown portion 44 of the bar conductor 38 extends over several slots 36 (e.g., each crown portion 44 may span five slots 36). Each bar conductor 38 inserted into a slot 36 is staggered or “interleaved” with respect to adjacent bar conductors 38. Any given slot 36 includes a pre-determined number of leg portions, and each leg portion within the slots 36 is referred to as a “layer” within the slot 36. It should be appreciated that the bar conductor 38 shown in FIG. 3 is only schematic, and is not meant to represent the span and/or twist of the bar conductors 38 as is known to those skilled in the art.

As shown in FIG. 2, each slot 36 of the stator assembly 24 includes four layers of bar conductors 38 (i.e., four leg portions) carrying either the same phase current or different phase current in the slot 36. The layers are referenced herein as the innermost layer (i.e., the layer closest to an inner diameter of the stator core 30) defined as layer 1, and the outermost layer (i.e., the layer furthest from the outer diameter of the stator core 30) defined as layer 4. However, it should be appreciated that each slot 36 may include some other number of layers of bar conductors 38, other than the four layers shown. The stator assembly 24 may include insulation (not shown) disposed between each leg portion situated within each slot 36 to prevent electrical connection between the leg portions in different layers of the same slot 36.

As described above, the winding set may define multiple phases. Additionally, the winding set further defines at least a first pole pair having a first pole and a second pole. A first pole pair is generally shown in FIG. 2 at 50, and a second pole pair is generally shown in FIG. 2 at 52. As shown in the Figures, the winding set of the stator assembly 24 includes three phases, and defines five pole pairs having a total of 10 poles. The stator assembly 24 includes two slots 36 per phase per pole. Accordingly, each pole pair spans across twelve adjacent or consecutive slots 36 of the stator core 30. However, it should be appreciated that the configuration of the stator assembly 24, and particularly the number of pole pairs, may differ from that shown and described herein.

A connection module 54 is coupled to the stator core 30 at one of the first axial end 32 and the second axial end 34 of the stator core 30. As shown, the connection module 54 is attached to the stator core 30 at the second axial end 34, i.e., at the weld end, adjacent the first bar ends 46 and the second bar ends 48 of the first leg portions 41 and the second leg portions 42 respectively. However, the connection module 54 may alternatively be attached to the stator core 30 at the first axial end 32, i.e., at the crown end. The connection module 54 spans across one complete pole pair of the winding set. As shown, the connection module 54 spans across the first pole pair 50 of the winding set. The connection module 54 is configured to connect each of the bar conductors 38 of each phase of the first pole pair 50 to complete each phase, and to interconnect each of the multiple phases in a pre-determined connection configuration. Additionally, the connection module 54 provides all external connections to the bar conductors 38 of the winding set to power and control the stator assembly 24.

The connection module 54 includes a substrate 56 supporting a plurality of electrical jumpers 58. The substrate 56 includes an electrically non-conductive material, such as but not limited to plastic, to electrically isolate each of the electrical jumpers 58 from all of the other electrical jumpers 58. Each of the electrical jumpers 58 is oriented on the substrate 56 in a pre-determined orientation relative to the stator core 30 to electrically engage at least two pre-determined bar conductors 38. The pre-determined orientation is dependent upon the exact configuration of the stator assembly 24, e.g., the number of winding sets, the number of phases and the number of pole pairs. Furthermore, the pre-determined orientation is also dependent upon the desired connection configuration, e.g., a wye connection configuration, a delta connection configuration, or an N-phase extension of the wye connection configuration or the delta connection configuration, sometimes referred to as a star connection system and a mesh connection system respectively.

As shown in FIGS. 4 and 5, the connection module 54 may include a plurality of insulators 60 attached to and supported by the substrate 56. Once the connection module 54 is positioned relative to the stator core 30, the insulators 60 extend from the substrate 56 radially toward the longitudinal axis 28, and also extend axially along the longitudinal axis 28. Each of the insulators 60 is oriented on the substrate 56 in a pre-determined orientation relative to the stator core 30 to electrically insulate between two adjacent bar conductors 38.

As noted above, the connection module 54 includes all external electrical connections required to power and control the plurality of bar conductors 38. Accordingly, referring back to FIG. 2, the connection module 54 may include at least one flexible lead 62 coupled to the substrate 56. The flexible lead 62 is oriented on the substrate 56 in a pre-determined orientation relative to the stator core 30 to electrically engage a pre-determined bar conductor 38. As shown, the at least one flexible lead 62 includes three flexible leads 62, with each of the three flexible leads 62 oriented on the substrate 56 to electrically engage a bar conductor 38 of a different phase. Furthermore, the connection module 54 includes a connection jumper 64 to connect the phases in the desired connection configuration. As shown, the connection module 54 includes a wye connection jumper 64 coupled to the substrate 56. The wye connection jumper 64 is oriented on the substrate 56 in a pre-determined orientation relative to the stator core 30 to electrically connect the three phases of the winding set in the wye connection configuration. However, it should be appreciated that if a different connection configuration is desired, e.g., a delta connection configuration, then the connection module 54 would include a different connection jumper specifically oriented on the substrate 56 to connect the phases in the desired connection configuration. Furthermore, the connection jumper 64 may be configured to connect any number of phases in an N-phase connection of the wye connection configuration or the delta connection configuration.

Referring to FIGS. 4 and 5, each of the electrical jumpers 58 includes a bore 66 extending therethrough and aligned with an aligned end of one of the bar conductors 38. Each of the electrical jumpers 58 is welded to their respective aligned end through the bore 66. It should be appreciated that each electrical jumper will include an identical bore 66 located at each end of the electrical jumper for connection to each of the two bar conductors 38 to which the electrical jumper interconnects.

Each of the bores 66 in each of the electrical jumpers 58 includes a concave recess 68. The concave recess 68 is disposed concentrically about an associated bore 66. The concave recess 68 is configured to isolate a weld joining the electrical jumper to the aligned end of one of the bar conductors 38 to prevent a short between adjacent electrical jumpers 58. The concave recess 68 provides an area for the weld to accumulate without pouring out over an edge of the electrical jumper and onto an adjacent electrical jumper. Preferably, the bore 66 includes a bore diameter 70 equal to approximately one millimeter, and the concave recess 68 includes a large diameter 72 approximately equal to two millimeters and tapers to a small diameter 74 approximately equal to one millimeter. It should be appreciated that the small diameter 74 is equal to the bore diameter 70. However, the exact diametrical size of the concave recess 68 and the bore 66 may differ from the dimensions described herein.

A method of manufacturing the stator assembly 24 is also described herein. The method includes forming the stator core 30 to define the plurality of slots 36 as described above. Once the stator core 30 is formed, the plurality of bar conductors 38 having identical spans are positioned within the plurality of slots 36. The bar conductors 38 are positioned to define at least one winding set that defines multiple phases, and further defines a first pole pair 50 having a first pole and a second pole. As shown in the drawings, the bar conductors 38 are positioned to define three phases and five pole pairs.

The method further includes selecting the connection module 54 from a group of different modules. Each of the different modules may be pre-assembled and ready for installation onto the stator core 30. Each of the different modules is designed to match with the specific winding set configuration of the stator assembly 24. For example, the stator assembly 24 shown in the Figures includes two winding sets, with each winding set including three phases, with two slots 36 per phase and four conductor ends per slot 36. As such, each of the different modules within the group of modules is designed to accommodate that specific configuration of the stator assembly 24. Accordingly, different configurations of the stator assembly 24 will include different modules within the group of modules. The specific connection module 54 used is chosen to achieve a desired output. For example, one module may be chosen to provide a wye connection configuration, and another different module may be chosen to provide a delta connection configuration. Each of the different modules orients the electrical jumpers 58 in a different orientation to define the different pre-determined connection configurations for the different outputs.

Once the desired connection module 54 is chosen, then the connection module 54 is positioned and/or attached relative to the stator core 30. The connection module 54 is positioned relative to the stator core 30 to span across an entire pole pair of the winding set, such as but not limited to the first pole pair 50.

Each of the electrical jumpers 58 is then electrically connected to the two pre-determined bar conductors 38 to complete each phase of the winding set and to interconnect each of the multiple phases in the pre-determined connection configuration. The electrical jumpers 58 may be electrically connected to the bar conductors 38 through any suitable process, including but not limited to welding each of the electrical jumpers 58 to one of the bar conductors 38 to create an electrical connection. As described above, the electrical jumpers 58 may be welded to the bar conductors 38 through the bore 66 defined by the electrical jumper. Furthermore, the method may further include electrically connecting each of the flexible leads 62 and the connection jumper, e.g., the wye connection jumper 64, to one of the bar conductors 38 associated with one of the multiple phases. The flexible leads 62 and the wye connection jumper 64 may be electrically connected through any suitable process, including but not limited to welding.

Because all of the electrical connections necessary to connect the bar conductors 38 within one complete pole of the winding set are provided by the connection module 54, there is no need for any unique and/or specially designed bar conductors 38 to make those electrical connections. Accordingly, the exact same bar conductors 38 may be used throughout the stator assembly 24, simplifying the assembly process and allowing for an automated, e.g., robotic, positioning process of the bar conductors 38 within the slots 36 of the stator. The remainder of the conductor ends, not connected through the connection module 54, are positioned adjacent each other and welded together as is known in the art.

While the best modes for carrying out the invention have been described in detail, those familiar with the art to which this invention relates will recognize various alternative designs and embodiments for practicing the invention within the scope of the appended claims.

1. A stator assembly for an electric device, the stator assembly comprising:
a stator core extending along a longitudinal axis between a first axial end and a second axial end and defining a plurality of slots extending along the longitudinal axis and angularly spaced about the longitudinal axis;
a plurality of bar conductors, each having an identical span and positioned within the slots to define at least one winding set defining multiple phases, and further defining a first pole pair having a first pole and a second pole;
a connection module coupled to the stator core at one of the first axial end and the second axial end of the stator core and spanning across the first pole pair of the winding set, wherein the connection module is configured to connect each of the bar conductors of each phase of the first pole pair to complete each phase, and to interconnect each of the multiple phases in a pre-determined connection configuration.

2. A stator assembly as set forth in claim 1 wherein the connection module includes a substrate supporting a plurality of electrical jumpers.

3. A stator assembly as set forth in claim 2 wherein the substrate is electrically non-conductive.

4. A stator assembly as set forth in claim 2 wherein each of the electrical jumpers is oriented on the substrate in a pre-determined orientation relative to the stator core to electrically engage at least two pre-determined bar conductors.

5. A stator assembly as set forth in claim 2 wherein the connection module includes at least one flexible lead coupled to the substrate and oriented on the substrate in a pre-determined orientation relative to the stator core to electrically engage a pre-determined bar conductor.

6. A stator assembly as set forth in claim 5 wherein the winding set defines three phases, and the at least one flexible lead includes three flexible leads, with each of the three flexible leads oriented on the substrate to electrically engage a bar conductor of a different phase.

7. A stator assembly as set forth in claim 2 wherein the winding set includes three phases, and the connection module connects the phases in one of a wye connection configuration, a delta configuration, an N phase extension of a wye connection configuration, or an N phase extension of a delta connection configuration.

8. A stator assembly as set forth in claim 7 wherein the connection module includes a connection jumper coupled to the substrate and oriented on the substrate in a pre-determined orientation relative to the stator core to electrically connect the phases of the winding set in a pre-determined connection configuration.

9. A stator assembly as set forth in claim 2 wherein the connection module includes a plurality of insulators attached to and supported by the substrate, wherein the insulators extend from the substrate radially toward the longitudinal axis, and extend axially along the longitudinal axis, with each of the insulators oriented on the substrate in a pre-determined orientation relative to the stator core to electrically insulate between two adjacent bar conductors.

10. A stator assembly as set forth in claim 2 wherein each of the electrical jumpers includes a bore extending therethrough and aligned with an aligned end of one of the bar conductors, wherein each of the electrical jumpers is welded to their respective aligned end through the bore.

11. A stator assembly as set forth in claim 10 wherein each of the electrical jumpers includes a concave recess disposed concentrically with an associated bore, wherein the concave recess is configured to isolate a weld joining the electrical jumper to the aligned end of one of the bar conductors to prevent a short between adjacent electrical jumpers.

12. A stator assembly as set forth in claim 11 wherein the bore includes a diameter equal to approximately one millimeter, and wherein the concave recess includes a large diameter approximately equal to two millimeters and tapers to a small diameter approximately equal to one millimeter.

13. A stator assembly as set forth in claim 1 wherein the connection module includes all external electrical connections required to power the plurality of bar conductors.

14. A stator assembly as set forth in claim 1 wherein each of the bar conductors includes a crown portion, a first leg portion and a second leg portion, with the first leg portion and the second leg portion extending from the crown portion to a first bar end and a second bar end respectively and disposed within different slots of the stator core, and wherein the crown portion of all of the bar conductors is disposed adjacent the first axial end of the stator core to define a crown end of the stator core, and wherein the first bar ends and the second bar ends of all of the bar conductors extend past the second axial end of the stator core along the longitudinal axis to define a weld end of the stator core.

15. A method of manufacturing a stator assembly for an electrical device, the method comprising:
forming a stator core to define a plurality of slots that extend along a longitudinal axis and are angularly spaced about the longitudinal axis;
positioning a plurality of bar conductors within the plurality of slots to define at least one winding set that defines multiple phases and defines a first pole pair having a first pole and a second pole, wherein each of the bar conductors include an identical span;
positioning a connection module relative to the stator core to span across the first pole pair, wherein the connection module includes a plurality of electrical jumpers, with each jumper oriented in a pre-determined orientation relative to the stator core to electrically engage at least two pre-determined bar conductors; and
electrically connecting each of the electrical jumpers to the at least two pre-determined bar conductors to complete each phase of the winding set and to interconnect each of the multiple phases in a pre-determined connection configuration.

16. A method as set forth in claim 15 further comprising selecting the connection module from a group of different modules to achieve a desired output, wherein each of the different modules orient the electrical jumpers in a different orientation to define a different pre-determined connection configuration for different outputs.

17. A method as set forth in claim 15 wherein electrically connecting each of the electrical jumpers includes welding each of the electrical jumpers to one of the bar conductors to create an electrical connection.

18. A method as set forth in claim 17 wherein welding each of the electrical jumpers to one of the bar conductors includes welding the bar conductor to the electrical jumper through a bore defined by the electrical jumper.

19. A method as set forth in claim 15 wherein the connection module includes a flexible lead for each of the multiple phases of the winding set, and wherein the method includes electrically connecting each of the flexible leads to one of the bar conductors associated with one of the multiple phases.

20. An electric device comprising:
a housing;
a rotor assembly rotatably supported by the housing; and
a stator assembly supported by and positionally fixed relative to the housing, with the rotor assembly rotatable relative to the stator assembly about a longitudinal axis, the stator assembly including:
a stator core extending along a longitudinal axis between a first axial end and a second axial end and defining a plurality of slots extending along the longitudinal axis and angularly spaced about the longitudinal axis;
a plurality of bar conductors, each having an identical span and positioned within the slots to define at least one winding set defining multiple phases, and further defining a first pole pair having a first pole and a second pole;
a connection module coupled to the stator core at one of the first axial end and the second axial end of the stator core and spanning across the first pole pair of the winding set, wherein the connection module is configured to connect each of the bar conductors of each phase of the first pole pair to complete each phase, and to interconnect each of the multiple phases in a pre-determined connection configuration;
wherein the connection module includes an electrically non-conductive substrate supporting a plurality of electrical jumpers;
wherein each of the electrical jumpers is oriented on the substrate in a pre-determined orientation relative to the stator core to electrically engage at least two pre-determined bar conductors;
wherein the connection module includes a flexible lead coupled to the substrate and oriented on the substrate in a pre-determined orientation relative to the stator core to electrically engage a pre-determined bar conductor associated with each different phase of the winding set;
wherein the connection module includes a connection jumper coupled to the substrate and oriented on the substrate in a pre-determined orientation relative to the stator core to electrically connect the phases of the winding set in a pre-determined connection configuration; and
wherein the connection module includes a plurality of insulators attached to and supported by the substrate, wherein the insulators extend from the substrate radially toward the longitudinal axis, and extend axially along the longitudinal axis, with each of the insulators oriented on the substrate in a pre-determined orientation relative to the stator core to electrically insulate between two adjacent bar conductors.
